(19) United States
(12) Patent Application Publication
(10) Pub. No.: US 2010/0096872 A1
(43) Pub. Date: Apr. 22, 2010

(54) CARGO SYSTEM FOR CARGO AREA OF VEHICLE

(76) Inventor: Gregory Ralph Brogdon, Gardena, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/500,849

(22) Filed: Jul. 10, 2009

Related U.S. Application Data
(60) Provisional application No. 61/106,084, filed on Oct. 16, 2008.

(51) Int. Cl. B60P 3/00

(52) U.S. Cl. 296/3

(57) ABSTRACT

A cargo system for use within the cargo area of a vehicle. The cargo system has an elongated crossbar and at least two brackets for supporting the crossbar while it spans the cargo area. The brackets may adapt a roof top storage rack for use in the cargo area or bed of a truck. The brackets may engage standard truck bed components such as D-rings, deck rails, and cleats to secure the cargo system. The cargo system may be positioned anywhere in the cargo area depending upon the positions, i.e., sidewall or bottom, of the supports for the brackets.

### BACKGROUND OF THE INVENTION

This invention relates generally to a cargo system for use with motor vehicles. More particularly, the present invention relates to brackets for a cargo system to adapt a roof top storage rack for use in the cargo area of a truck bed. The brackets come in various forms to adapt a storage rack for mounting at various places in a truck bed so as to leave the bed of the truck beneath the storage rack available for additional stowage.

The inventive cargo system and related adaptor brackets birthed from necessity. As a truck owner, the inventor found that there was no commercially available storage rack on the market to mount in his truck bed to suit his needs. Thus, the inventor began to develop an inexpensive, functional rack system for his own personal use.

The leading vehicle cargo rack management systems (e.g. Thule® and Yakima®) are mostly comprised of roof top or roof gutter mountable rack systems. The only storage devices that utilize standard deck rails in a truck bed are for bikes. There is nothing on the market that uses a common crossbar accessory that is not mounted to a roof top rain gutter or vertical utility rack projected high above the bed of the truck. The Toyota® Cargo Bar (PT78535053) was not functional for the intended uses. The inventor wanted something that would hold surfboards and other equipment besides bikes safely on the back open bed of the truck without losing the use of the bed.

U.S. patent application publication no. 2008/0230665 to Palermo discloses a mounting bracket for a rack system. The bracket in Palermo is configured to engage and be secured to top of the sidewall. Palermo has the drawback that it can only be mounted at the top of the sidewall. Such design limits where the cargo system can be mounted in the cargo area and what other truck bed accessories can be used with the cargo system.

Accordingly, there is a need for a cargo system that is easily adapted to the cargo area or bed of a truck in a manner that is compatible with other truck bed accessories. In addition, there is a need for adaptor brackets that can adapt commercially available crossbars for use in the cargo area or bed of a truck. The present invention satisfies these needs and provides other related advantages.

### SUMMARY OF THE INVENTION

The inventor developed a bracket that adapts standard truck bed components, such as D-rings, deck rails, and cleats, into a rack system. The adaptor brackets enable one to fit commercially available roof top cargo systems and crossbar accessories into the brackets creating a simplistic and diverse rack system. Brackets attach to standard tie downs/cleats & deck rails providing quick adjustability and removal.

Cargo systems for use in the cargo area of a vehicle designed in accordance with the present invention comprise, generally, an elongated crossbar and first and second brackets. The elongated crossbar has a length that substantially spans the cargo area. The first and second brackets each have a clamp at a first end and a mount at a second end. The clamp is configured to engage the crossbar. The mount is configured to engage supports in the cargo area. The supports in the cargo area are positioned entirely within the volume of the cargo area.

The cargo system is preferably configured to adapt a roof top storage rack for use in the cargo area. The elongated crossbar is preferably part of the roof top storage rack. Such crossbar may have a round or polygonal cross-section and be configured to receive a storage device. The cargo system preferably comprises two elongated crossbars, and first and second brackets for each crossbar.

The cargo area is preferably a truck bed. The mounts of the first and second brackets are configured to engage supports on a bottom of the truck bed. Alternatively, the mounts are configured to engage supports on sidewalls of the truck bed a predetermined distance above the bottom of the truck bed. The supports in the cargo area preferably comprise a deckrail, a D-ring, or a cleat. The clamps of the first and second brackets have a cross-section that matches the cross-section of the crossbar.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is an illustration of the cargo area of a truck including the inventive cargo system;

FIG. 2 is a close-up illustration of an inventive bracket and crossbar;

FIG. 3 is an illustration of a preferred embodiment of the bracket of the inventive cargo system;

FIG. 4 is cross section taken along line 4-4 of FIG. 3;

FIG. 5 is an alternate embodiment of the bracket shown in FIG. 3;

FIG. 6 is an illustration of another preferred embodiment of the bracket of the inventive cargo system;

FIG. 7 is cross section taken along line 7-7 of FIG. 6;

FIG. 8 is an alternate embodiment of the bracket shown in FIG. 6;

FIG. 9 is an illustration of yet another preferred embodiment of the bracket of the inventive cargo system;

FIG. 10 is cross section taken along line 10-10 of FIG. 9; and

FIG. 11 is an alternate embodiment of the bracket shown in FIG. 9.

### DETAILED DESCRIPTION OF THE PREFERRED EMBODIMENTS

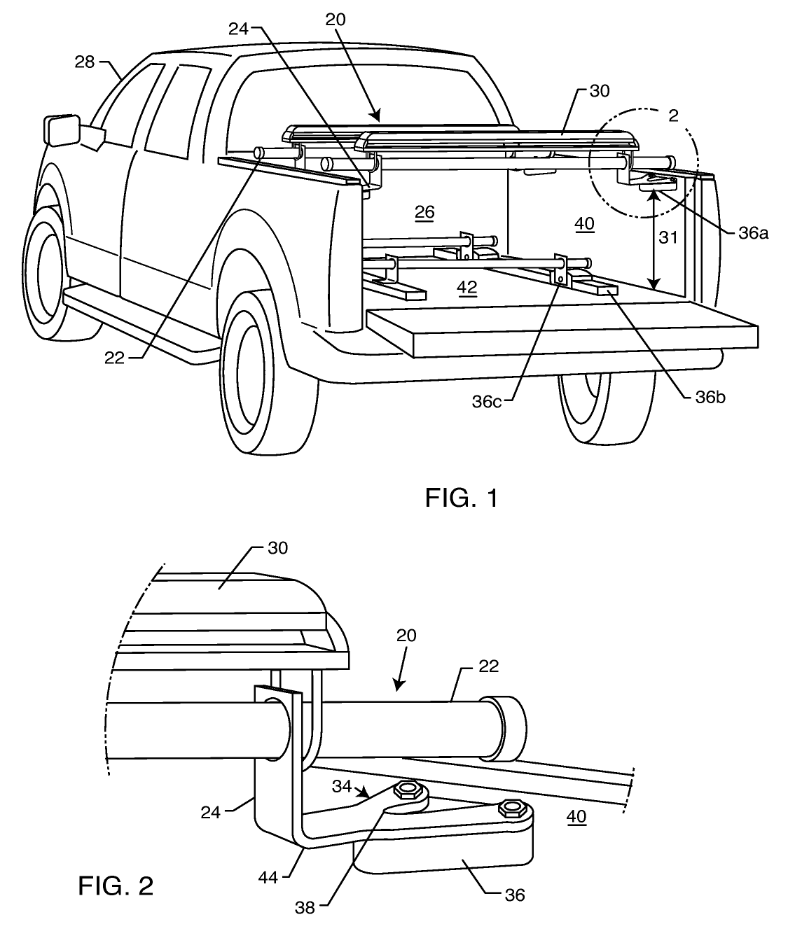

With reference now to FIG. 1, the cargo system of the present invention is generally referred to by reference numeral 20. The cargo system 20 comprises an elongated crossbar 22 and brackets 24. The cargo system 20 is preferably designed for mounting in the cargo area or bed 26 of a truck 28. The crossbar 22 is configured to receive a storage device 30. The storage device 30 may be a clamping device, a cargo container, or similar commercially available device. Such storage device 30 is designed to secure and retain equipment, i.e., surfboards, bicycles, skis, snowboards, etc.

As illustrated in FIG. 1, the cargo system 20 is preferably mounted a pre-determined distance 31 above the bottom of the cargo area 26 so as to permit additional stowage of cargo beneath the cargo system 20. This pre-determined distance is adjustable depending upon the height at which supports (see below) are mounted in the cargo area 26. However, as also shown in FIG. 1, the cargo system 20 may be mounted on the bottom of the cargo area 26. Although FIG. 1 illustrates the cargo system 20 installed in multiple locations in the cargo area 26, it is intended that the system 20 be installed only as necessary to meet the storage needs of the user.

The elongated crossbar 22 preferably has a round or polygonal cross-section and is configured to span the width of the cargo area 26. The elongated crossbar 22 may be specifically designed for use with the inventive cargo system 20. Alternatively, a crossbar 22 from a commercially available roof top storage rack such as a Thule® and Yakima® brand rack may be used with brackets 24 according to the present invention. As explained above, such roof top racks are configured to engage rain gutters or roof edges on vehicles. The stands (not shown) that attach such roof top racks to the rain gutter or roof edge on a vehicle roof are not configured to engage supports (see below) in the cargo area 26 of a truck 28. Accordingly, the brackets 24 of the present invention must be substituted for the stands of the commercially available roof top storage racks when adapting a roof top rack for use in the cargo area 26.

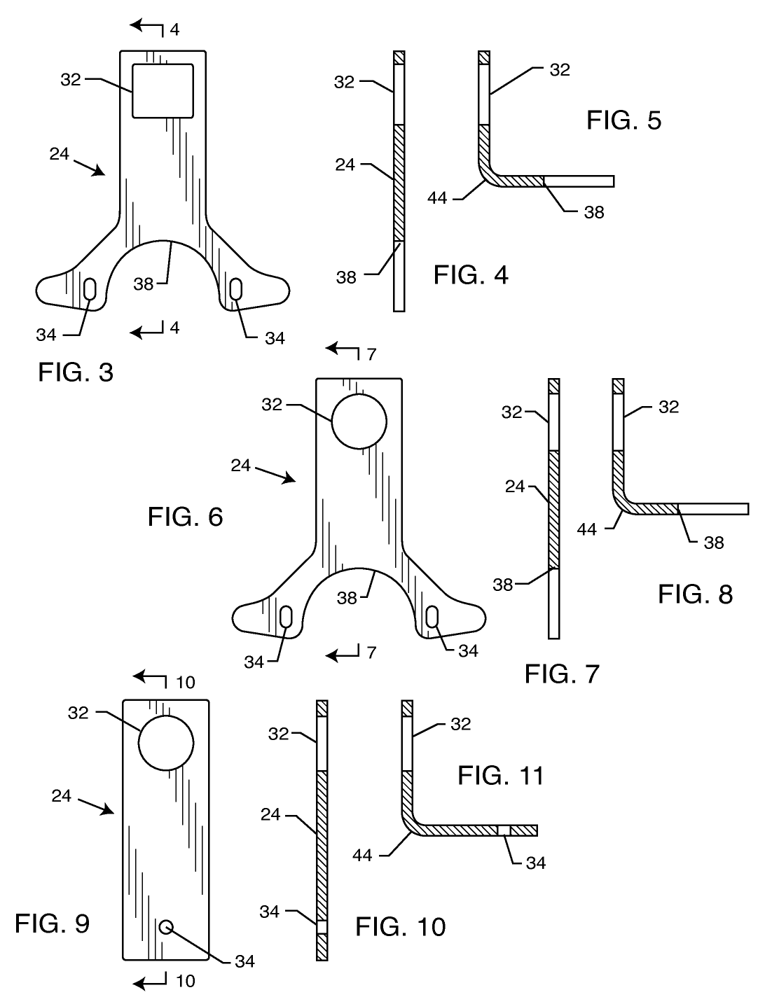

As shown in FIGS. 1 and 2, the brackets 24 preferably comprise first and second brackets—one for securing each end of the crossbar 22. As shown in FIGS. 3-11, each bracket 24 includes a clamp 32 at one end and a mount 34 at an opposite end. The clamp 32 has a cross-section to match the cross-section of the crossbar 22 and is configured to engage and securely hold one end of the crossbar 22. The clamp 32 may comprise a mechanical clamp (not shown) designed to be tightened by a screw or similar device to hold the crossbar 22. Alternatively, the clamp 32 may comprise an opening in the bracket 24. As the crossbar 22 is positioned in the clamp opening 32, the bracket 24 can be configured to have an angled engagement with the crossbar 22 when the mount 34 is secured as described below so as to “pinch” or otherwise grasp the crossbar 22. This angled engagement assures that the crossbar 22 is held securely in place by first and second brackets 24 positioned at each end of the crossbar 22.

The mount 34 is configured to engage a support 36 in the cargo area 26. The mount 34 may comprises one or more openings to engage mated portions of a support 36. The support 36 may comprise any standard truck bed tie down component such as a cleat 36a, a deck rail 36b, a D-Ring 36c or similar structure available from most truck manufacturers. The support 36 may be positioned anywhere in the interior of the cargo area 26, i.e., on the sidewall 40 or bottom 42. This versatility provides for greater flexibility in where the cargo system 20 is positioned in the cargo area 26 and whether it will interfere with other accessories used in the cargo area 26, i.e., truck bed covers, slidable cargo carriers, etc. Alternatively, the mount 34 may be removably bolted to the top edge of the sidewall without a support 36 or to the top of a hard cover over the cargo area 26.

With the ability to adjust the height of the supports 36, it is possible to have the entire cargo system 20 within the volume of the cargo area 26. This allows for use of the cargo system 20 with a truck bed cover or similar accessory that must engage the top edge of the sidewall. The mount 34 may also include a cutout or notch 38 to allow access to an adjustment device on the support 36. This allows the position of the support 36 in the cargo area 26 to be adjusted without having to remove the bracket 24. It is important that the support 36 be positioned entirely within the interior of the cargo area 26 so as not to interfere with other accessories.

Depending on the positioning of the support 36 in the cargo area 24, i.e., on the sidewall 40 or bottom 42, the bracket 24 may include a bend 44. The bend 44 may be necessary to assure that the clamp 32 properly engages the crossbar 22 depending upon the orientation of the support 36. As shown in FIGS. 2, 5, 8 and 11, the support 24 with bend 44 allows for the mounts 34 to engage the supports 36 horizontally while providing the clamps 32 at the proper orientation to engage the crossbar 22. Alternatively, FIGS. 4, 7, and 10 show the support 24 without bend 44 where the mounts 34 can engage the supports 36 vertically while providing the clamps 32 at the proper orientation to engage the crossbar 22.

The brackets 24 are distinguished from the stands used to attach prior art rooftop cargo racks to vehicles. In the prior art, the stands are configured to engage gutters or edges of the roof whereby hooks on the stands engage the same from the outside and pull inward. In contrast, the brackets 24 of the present invention engage the supports 36 in line with or from the inside of the cargo area 26. With such configuration, the supports 36 and brackets 24 will not interfere with or interrupt the top edge of the sidewall as described above. By engaging from the inside of the cargo area 26, it is not necessary to have the brackets 24 pass over the top edge of the sidewall or engage an exterior of the sidewall.

The parts of the cargo system 20 can be made of aluminum, steel, plastic, composite or other materials possessing suitable strength and durability qualities. Where the supports 36 comprise deck rails, it is possible to slide the inventive cargo system 20 on the deck rail system to adjust to various positions. These positions include sliding the cargo system 20 forward to increase the cargo area 26 available for other storage or sliding the cargo system 20 completely out of the deck rails for quick removal.

Although several embodiments of the invention have been described in detail for purposes of illustration, various modifications of each may be made without departing from the spirit and scope of the invention. Accordingly, the invention is not to be limited, except as by the appended claims.

What is claimed is:

1. A cargo system for use in a cargo area of a vehicle, the cargo system comprising:
an elongated crossbar having a length that substantially spans the cargo area; and
first and second brackets, each bracket having a clamp at a first end configured to engage the crossbar and a mount at a second end configured to engage supports in the cargo area, wherein the supports are positioned entirely within the interior of the cargo area.

2. The cargo system of claim 1, wherein the cargo system adapts a roof top storage rack for use in the cargo area.

3. The cargo system of claim 2, wherein the elongated crossbar is part of the roof top storage rack.

4. The cargo system of claim 1, wherein the elongated crossbar is configured to receive a storage device.

5. The cargo system of claim 1, wherein the cargo area is a truck bed.

6. The cargo system of claim 5, wherein the mounts of the first and second brackets are configured to engage supports on a bottom of the truck bed or supports on sidewalls of the truck bed a predetermined distance above the bottom of the truck bed.

7. The cargo system of claim 1, wherein the cargo system comprises two elongated crossbars, and first and second brackets for each crossbar.

8. The cargo system of claim 1, wherein the supports in the cargo area comprise a deck rail, a D-ring, or a cleat.

9. The cargo system of claim 1, wherein the crossbar has a round or a polygonal cross-section and the clamp has a matching cross-section.

10. A cargo system to adapt a roof top storage rack for use in a cargo area of a vehicle, the cargo system comprising:
an elongated crossbar having a length that substantially spans the cargo area, the crossbar configured to receive a storage device; and
first and second brackets, each bracket having a clamp at a first end configured to engage the crossbar and a mount at a second end configured to engage supports in the cargo area, wherein the supports are positioned entirely within the interior of the cargo area.

11. The cargo system of claim 10, wherein the elongated crossbar is part of the roof top storage rack.

12. The cargo system of claim 10, wherein the cargo area is a truck bed.

13. The cargo system of claim 12, wherein mounts of the first and second brackets are configured to engage supports on a bottom of the truck bed or supports on sidewalls of the truck bed a predetermined distance above the bottom of the truck bed.

14. The cargo system of claim 10, wherein the cargo system comprises two elongated crossbars, and first and second brackets for each crossbar.

15. The cargo system of claim 10, wherein the supports in the cargo area comprise a deck rail, a D-ring, or a cleat.

16. The cargo system of claim 10, wherein the crossbar has a round or a polygonal cross-section and the clamp has a matching cross-section.

17. A cargo system to adapt a roof top storage rack for use in a bed of a truck, the cargo system comprising:
an elongated crossbar as part of the roof top storage rack, the crossbar having a length that substantially spans the cargo area, and the crossbar configured to receive a storage device; and
first and second brackets, each bracket having a clamp at a first end configured to engage the crossbar and a mount at a second end configured to engage supports in the cargo area, wherein the supports are positioned entirely within the interior of the cargo area.

18. The cargo system of claim 17, wherein mounts of the first and second brackets are configured to engage supports on a bottom of the truck bed or supports on sidewalls of the truck bed a predetermined distance above the bottom of the truck bed, wherein the supports comprise a deckrail, a D-ring, or a cleat.

19. The cargo system of claim 17, wherein the cargo system comprises two elongated crossbars, and first and second brackets for each crossbar.

20. The cargo system of claim 17, wherein the crossbar has a round or a polygonal cross-section and the clamp has a matching cross-section.
